(19) United States
(12) Patent Application Publication
(10) Pub. No.: US 2010/0090945 A1
(43) Pub. Date: Apr. 15, 2010

(54) VIRTUAL INPUT SYSTEM AND METHOD

(75) Inventors: Chia Hoang Lee, Maoli (TW); Yi An Chen, Pingtung (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: National Chiao Tung University, Hsinchu City (TW)

(21) Appl. No.: 12/476,971

(22) Filed: Jun. 2, 2009

(30) Foreign Application Priority Data
Oct. 9, 2008 (TW) 097139003

(51) Int. Cl. G09G 5/00; G06F 3/048

(52) U.S. Cl. 345/156; 715/773

(57) ABSTRACT

The invention provides a virtual input system. The virtual input system comprises a trajectory generating apparatus and a receiving apparatus. The receiving apparatus comprises a sensing module, a coding module, a database, and a comparing module. The sensing module is used for sensing a trajectory information of the trajectory generating apparatus. The coding module converts the trajectory information to a specific code series according to a coding rule. The database stores a plurality of reference code series and a plurality of reference symbols corresponding to the plurality of reference code series. The comparing module compares the specific code series with the plurality of reference code series to determine at least one candidate symbol from the plurality of reference symbols.

### BACKGROUND OF THE INVENTION

1. Field of the Invention

The present invention generally relates to the input of characters, and more particularly, to a virtual input system and method.

2. Description of the Prior Art

In recent years, with the vigorous development of mobile communication technology, mobile phone has already become one of the most important communication tools in our daily life. When a user wants to use a mobile phone to send out a short message or minute a schedule, he/she has to enter various characters into the mobile phone. To enter Chinese characters into the mobile phone, various character input methods generated accordingly.

In these inputting methods, the most conventional method is a key inputting method. For example, when a user wants to input a Chinese character into the mobile phone by the keyboard inputting method, he/she has to know the code that the Chinese character corresponds to (for example, the phonetic symbols that the Chinese character corresponds to) and then presses each of the keys corresponding to codes sequentially. When the mobile phone shows the plurality of candidate characters according to the keys the user presses, the user has to select a suitable character from the candidate characters to finish the inputting process. The most serious problem of this method is that its inputting efficiency is quite low for the user, a lot of time and energy must be wasted to perform the character inputting procedure.

In addition to the above-mentioned key inputting method, many mobile phones also provide the handwriting input function presently; the user can use a handwriting pen to write on the monitor to input characters. However, the handwriting input method has many drawbacks, such as the handwriting pen is inconvenient for the user to carry, the recognition of handwritten characters is still poor and the screen size of the mobile phone is limited, etc. Therefore, the handwriting input method is still inconvenient for the user.

On the other hand, some mobile phones on the market can also provide the voice inputting function. After the user starts the voice calling function of the mobile phone, the user only needs to directly speak the name or the number he/she wants to call toward the mobile phone, the mobile phone will make the call automatically. However, the recognition of the inputted voice is still poor, and the inputted voice is easily interfered by the noise from the surrounding environment. If the user speaks with one of the following situations, such as the volume is too small, the pronunciation is not standard, or the speaking speed is too fast, the inputted voice will not be correctly recognized.

Accordingly, the main scope of the present invention is to provide a virtual input system and method to solve the problems mentioned above.

### SUMMARY OF THE INVENTION

A scope of the present invention is to provide a virtual input system and a virtual input method. The virtual input system transforms the moving trajectory, generated by the user moving the trajectory generating apparatus, to the character via the coding method, so that the user can input characters more easily and conveniently.

A first embodiment according to the invention is a virtual input system. In this embodiment, the virtual input system comprises a trajectory generating apparatus and a receiving apparatus. The receiving apparatus comprises a sensing module, a coding module, a database, and a comparing module, wherein the coding module is coupled to the sensing module; the comparing module is coupled to the coding module and the database.

In this embodiment, the sensing module is used for sensing a trajectory information related to the trajectory generating apparatus, the trajectory information can include at least one trajectory information formed when the user moves the trajectory generating apparatus. The coding module is used for coding the at least one moving trajectory of the trajectory information to the at least one specific code to form a specific code series according to a coding rule. The database stores a plurality of reference code series and the plurality of reference code series corresponding to the plurality of reference symbols. The comparing module compares the specific code series with the plurality of reference code series to determine at least one candidate symbol from the plurality of reference symbols. In practical applications, the reference symbol can be a character, a drawing, a number, or other forms not limited to the character.

A second embodiment according to the invention is a virtual input method. In this embodiment, firstly, the virtual input method generates a trajectory information. In fact, the trajectory information can include at least one trajectory information formed when the user moves the trajectory generating apparatus. Next, the virtual input method codes the at least one moving information of the trajectory information to the at least one specific code to form a specific code series according to a coding rule. Afterward, the virtual input method determines at least one candidate symbol from the plurality of reference symbols according to the specific code series with the plurality of reference code series, wherein the plurality of reference symbols correspond to the plurality of reference code series. In practical applications, the reference symbol can be a character, a drawing, a number, or other forms.

Compared to the prior art, the virtual input system and method of the invention can provide the user with a new human-machine interacting mode. When the user wants to input a character, the user only needs to move the trajectory generating apparatus in the air to write the character, the virtual input system will sense the moving trajectory of the trajectory generating apparatus, and lists the candidate characters similar to the moving trajectory according to the moving trajectory, so that the user can select the correct character from the candidate characters.

Accordingly, the virtual input system can apply to a general portable electronic apparatus to provide the user with a convenient and humanized character inputting method, and the various problems in the conventional character inputting method can be solved.

The objective of the present invention will no doubt become obvious to those of ordinary skills in the art after reading the following detailed description of the preferred embodiment, which is illustrated in the various figures and drawings.

### BRIEF DESCRIPTION OF THE APPENDED DRAWINGS

FIG. 1 illustrates a functional block diagram of the virtual input system in a first embodiment of the invention.

FIG. 2 illustrates a detailed functional block diagram of the sensing module shown in FIG. 1.

FIG. 3(A) illustrates the four directional vectors used to define Chinese characters in the virtual inputting system.

FIG. 3(B) illustrates a corresponding relationship between the strokes and codes in the coding rule.

FIG. 3(C) shows an example of coding a character to a code series.

FIG. 3(D) illustrates an example of the operating view in the virtual input system.

FIG. 4 illustrates a flowchart of the virtual input method in a second embodiment of the invention.

FIG. 5 illustrates a detailed flowchart of step S12 shown in FIG. 4.

FIG. 6 illustrates a detailed flowchart of step S14 shown in FIG. 4.

FIG. 7 illustrates a functional block diagram of the virtual input system in a third embodiment of the invention.

FIG. 8 illustrates a detailed functional block diagram of the sensing module shown in FIG. 7.

### DETAILED DESCRIPTION OF THE INVENTION

The present invention provides a virtual inputting system and a virtual inputting method. The virtual inputting system can code a moving trajectory, generated when a user moves a trajectory generating apparatus, to the inputting symbol via the coding method, so that the user does not have to press a key or write on a handwriting board in order to make inputting symbols easy and convenient. It should be noticed that the symbol described in the invention can be a character, a number, a drawing, or other forms, and it can be inputted by the virtual inputting system and the method of the invention, but not limited to the character.

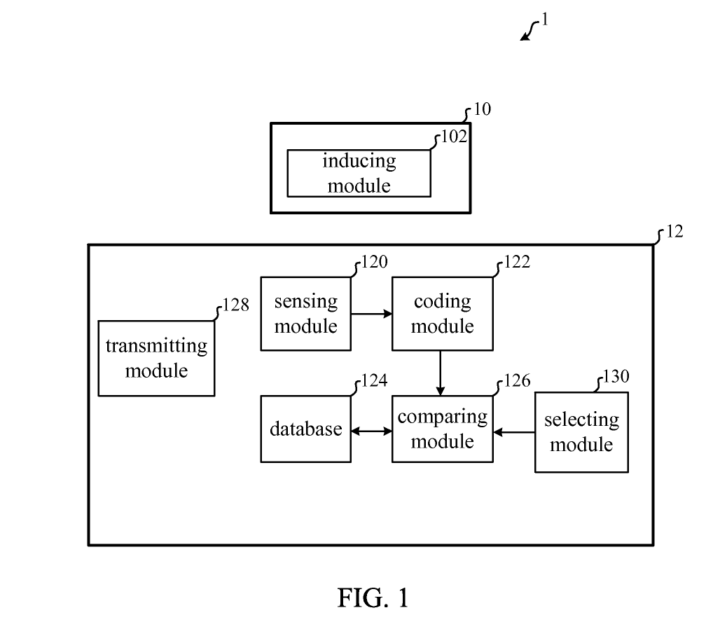

According to the first embodiment of the invention is a virtual inputting system. Please refer to FIG. 1. FIG. 1 illustrates a functional block diagram of the virtual input system. As shown in FIG. 1, the virtual inputting system 1 includes a trajectory generating apparatus 10 and a receiving apparatus 12. In this embodiment, the receiving apparatus 12 includes a sensing module 120, a coding module 122, a database 124, a comparing module 126, and a selecting module 130. The coding module 122 is coupled to the sensing module 120; the comparing module 126 is coupled to the coding module 122 and the database 124; the selecting module 130 is coupled to the comparing module 126. Next, the modules of the virtual input system 1 and their functions will be respectively introduced in detail as follows.

In practical applications, the trajectory generating apparatus 10 can include an inducing module 102; the receiving apparatus 12 can include a transmitting module 128. The transmitting module 128 is used for transmitting an infrared signal outward; the inducing module 102 is used for inducing the infrared signal transmitted from the transmitting module 128 and sending out a responding signal. Therefore, in the virtual input system 1, the signal can be transmitted and interacts between the trajectory generating apparatus 10 and receiving apparatus 12 through the infrared, but not limited to this.

In the virtual input system 1, the user can move the trajectory generating apparatus 10 to write in the air the character or the drawing he/she wants to input. In this embodiment, two operating modes used by the user to input via the trajectory generating apparatus 10 will be discussed as follows.

The first operating mode is a continuous inputting mode. In this mode, when the user wants to start inputting a first stroke of a character through the trajectory generating apparatus 10, the user has to press the functional key of the trajectory generating apparatus 10 to inform the receiving apparatus 12 that the user is ready to input the character. When the user finishes the input of the last stroke of the character, he/she has to press the function key to inform the receiving apparatus 12 that the user has finished the input of the character.

The second operating mode is a discontinuous inputting mode, except for the beginning and the end of inputting the whole character, when the user inputs every stroke of the character, the user needs to press the functional key of the trajectory generating apparatus 10 before the beginning of inputting that stroke and after the end of inputting that stroke to inform the receiving apparatus 12 that the user has finished the input of that stroke.

Then, the modules of the receiving apparatus 12 will be introduced. When the user moves the trajectory generating apparatus 10 in the air, the sensing module 120 of the receiving apparatus 12 will sense the trajectory information of the trajectory generating apparatus 10. In fact, the trajectory information can include at least one moving trajectory formed when the trajectory generating apparatus 10 moves.

The sensing module 120 not only can use the infrared to sense the moving trajectory of the trajectory generating apparatus 10, but also get the moving trajectory of the trajectory generating apparatus 10 through an image capturing method. However, there are still other methods to sense the moving trajectory of the trajectory generating apparatus 10, not limited to these two methods.

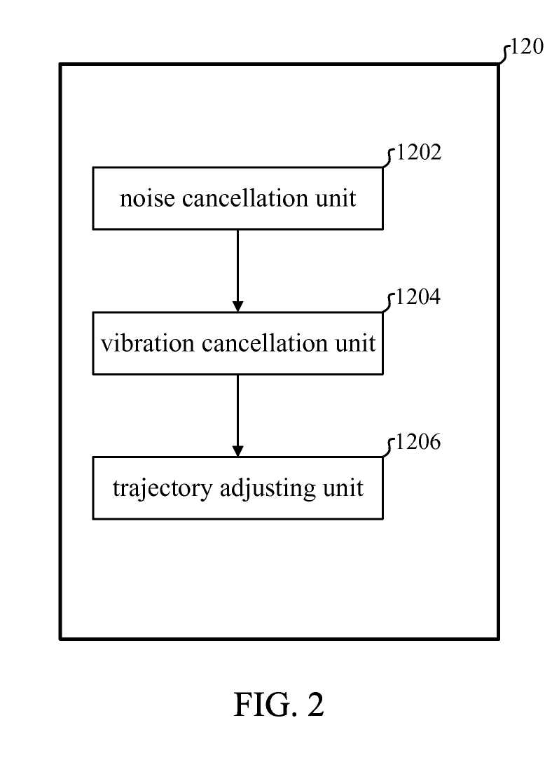

In this embodiment, in order to avoid the situation in which the trajectory information sensed by the sensing module 120 is difficult to be judged in the following procedures due to vibration and noise, the sensing module 120 will execute some pre-treatment processes for the trajectory information. Please refer to FIG. 2. FIG. 2 illustrates a detailed functional block diagram of the sensing module 120 shown in FIG. 1. As shown in FIG. 2, the sensing module 120 includes a noise cancellation unit 1202, a vibration cancellation unit 1204 and a trajectory adjusting unit 1206. The function of these three units will be introduced in the following.

Firstly, the noise cancellation unit 1202 is used for cancelling some noises the trajectory information may include. In fact, the noise can be tiny shift information. Because the displacement of the shift information is not obvious enough, the virtual input system 1 can be used without the shift information, even these local vibrations will bother the following analysis procedure. Therefore, the virtual input system 1 uses the noise cancellation 1202 to cancel the shift information. If the displacement of the shift information is smaller than a default value, the shift information will be regarded as a hand-shaking noise and canceled by the noise cancellation 1202.

Then, the vibration cancellation unit 1204 is used for cancelling the vibration of the trajectory information caused by the user. When the user moves the trajectory generating apparatus 10 to write the character in the air, the user usually will not pointlessly move about the trajectory generating apparatus 10. Therefore, the vibration cancellation unit 1204 can estimate the direction of the trajectory generating apparatus 10 moved by the user according to some prior information. If the trajectory information sensed by the sensing module 120 does not match the estimated trajectory information, the vibration cancellation unit 1204 will suitably adjust the sensed trajectory information, so that the adjusted trajectory information can match the estimated trajectory information. In this embodiment, the vibration cancellation unit 1204 adjusts the over-shifting trajectory information according to the concept of calculating the least mean square.

The estimated moving direction calculated by the vibration cancellation unit 1204 can be further used by the trajectory adjusting unit 1206, and the trajectory adjusting unit 1206 will project the sensed trajectory information onto the directional vector of the estimated moving direction. When the sensed trajectory information deviates from the estimated trajectory information, the trajectory adjusting unit 1206 will adjust the sensed trajectory information according to the estimated trajectory information.

After the above-mentioned signal processing procedures performed by the sensing module 120, the sensing module 120 will transmit the processed trajectory information to the coding module 122. When the coding module 122 receives the trajectory information, the coding module 122 will code the trajectory information to a specific code series according to a coding rule. In this embodiment, the coding rule is used for coding each moving trajectory of the trajectory information to the corresponding specific code and generating the specific code series corresponding to the trajectory information according to all of the coded specific codes. Then, the following examples are used to explain how the coding module 122 codes the trajectory information to the specific code according to the coding rule.

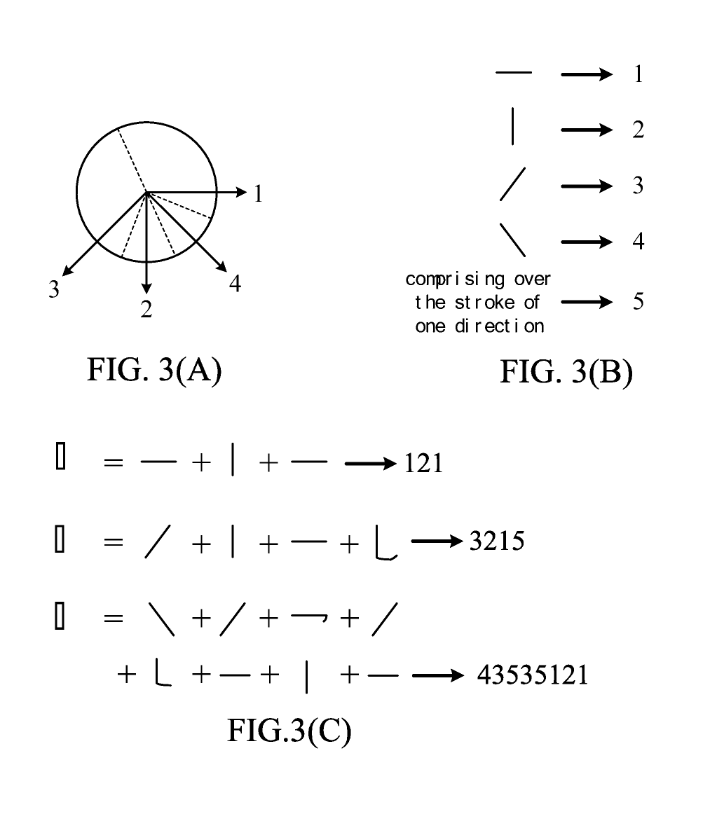

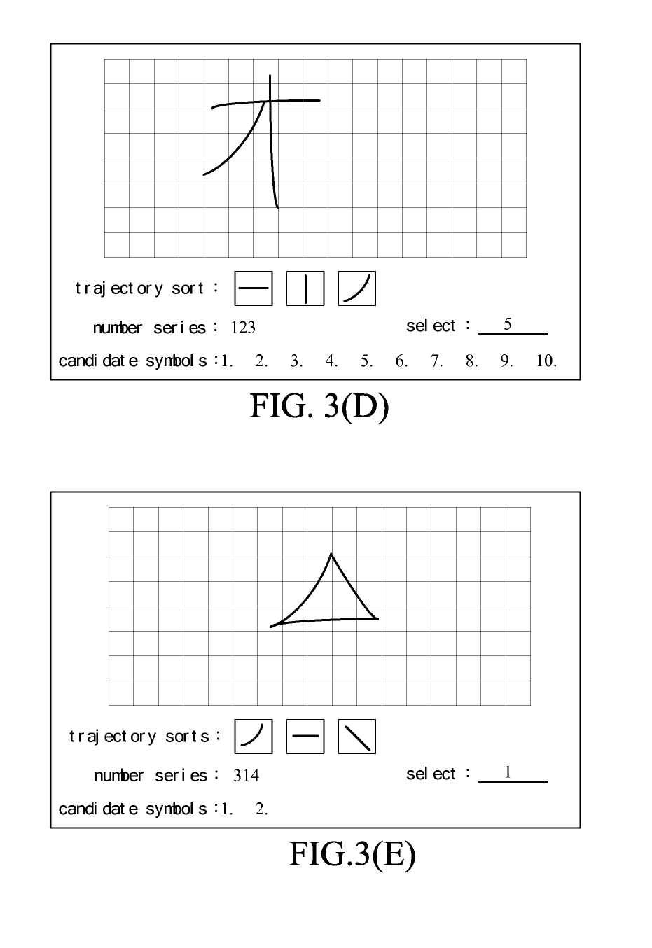

Please refer to FIG. 3(A). FIG. 3(A) is a circle diagram showing the classification of the strokes of characters corresponding to different codes in the coding rule. As shown in FIG. 3 (A), for Chinese characters, the virtual input system 1 defines four directional vectors, and each directional vector corresponds to Code 1˜Code 4 respectively. These four directional vectors divide the whole circle region of 360 degrees into four sub-regions.

In practical applications, because everyone has his/her own style to write the strokes of characters, therefore, in the virtual input system 1, these definitions of the directional vectors can be adjusted according to the user's preferences, so that the user can input the characters easily.

When the user holds the trajectory generating apparatus 10 to write a stroke in the air, the sensing module 120 of the receiving apparatus 12 will sense the moving trajectory when the user writes the stroke, and projects the vectors corresponding to each two adjacent points in the moving trajectory onto the four above-mentioned directional vectors, so that these four directional vectors can get new weighting values. As the moving trajectory information is continuously inputted, if the accumulated weighting value of a directional vector is over a threshold, it means the moving trajectory of this stroke has the feature of the directional vector. Therefore, the moving trajectory of the stroke will be coded correspondingly to the directional vector.

In addition, the moving trajectory of a single stroke can have a feature of various directional vectors, and this moving trajectory will be coded to Code 5. Namely, in this embodiment, Code 5 represents the moving trajectory including two or more directional features.

Please refer to FIG. 3(B). FIG. 3(B) illustrates a corresponding relationship between the strokes and codes in the coding rule. As shown in FIG. 3(B), it is assumed that in the coding rule, the stroke “ [symbol] ” corresponds to Code 1; the stroke “|” corresponds to Code 2; the stroke “/” corresponds to Code 3; the stroke “\” corresponds to Code 4; other strokes having two or more directional features (i.e., [symbol] ) corresponds to Code 5. Next, several examples will be introduced to explain how to code the Chinese character to the code series.

From FIG. 3(C), according to the above-mentioned coding rule, the character “ [symbol] ” includes three strokes in a sequence of “ [symbol] ”, “|”, and “ [symbol] ”, so “ [symbol] ” can be coded to a code series “121”. Similarly, the character “ [symbol] ” can be coded to a code series “3215”, and the character “ [symbol] ” can be coded to a code series “43535121”.

In this embodiment, the database 124 stores a plurality of reference code series and a plurality of reference characters corresponding to the plurality of reference code series, therefore, after the coding module 122 codes the trajectory information to the specific code series sensed by the sensing module 120, the comparing module 126 can compare the specific code series with the plurality of reference code series, and determines one or more candidate characters from the plurality of reference characters according to the compared result for the user to select.

In practical applications, the comparing module 126 can select one or more approximate code series similar with the specific code series from the plurality of reference code series stored in the database 124 according to the specific code series. Since each reference code series corresponds to one or more reference characters, the approximate code series will correspond to some approximate characters, and the comparing module 126 can distinguish at least one candidate character from these approximate characters.

There are many possible ways for the comparing module 126 to compare the specific code series with the plurality of reference code series to find out the approximate code series. For example, the comparing module 126 can use the simplest one by one comparing method to compare the specific code series with each reference code series in the database 124 respectively. If the approximate degree of the feature of the reference code series and the specific code series is over a default value, the reference code series can be regarded as an approximate code series of the specific code series, and the approximate code series corresponding to the reference character can be regarded as a candidate character corresponding to the trajectory information.

In fact, the comparing module 126 can provide a comparing score according to the approximate degree of the features of each reference code series and the specific code series, and then select the candidate characters according to the comparing scores to list the candidate characters for the user to select.

On the other hand, the comparing module 126 can also combine a certain part of regions of the specific code series or the reference code series to form a feature of the radical structure. The method can also help the comparing module 126 to find out the approximate code series more accurately and can further get the candidate characters corresponding to the trajectory information.

After the comparing module 126 finishes the comparing work and gets the candidate characters corresponding to the trajectory information, the selecting module 130 is used for selecting the objective character corresponding to the trajectory information from the candidate characters. In practical applications, the selecting module 130 can include a user interface (not shown in the figure), such as a touch panel. The user can select the objective character he/she wants to input from the candidate characters through the user interface, the practical operation frame is shown in FIG. 3(D).

As shown in FIG. 3(D), if the moving trajectories of the first three strokes sensed by the sensing module 120 are “ [symbol] ”, “|”, and “/” respectively, the coding module 122 can get a specific code series “123” according to the moving trajectories of these first three strokes. Next, the comparing module 126 will compare the specific code series “123” and the plurality of reference code series stored in the database 124, and then the comparing module 126 will list the ten most similar candidate characters for the user to select. In this example, if the user wants to input the character “ [symbol] ”, the user will select the candidate character of No. 5.

In practical applications, even when the user only inputs parts of the strokes of the character, the comparing module 126 can still perform the comparing work and list the most likely candidate characters. Furthermore, the comparing module 126 can also perform the comparing work and list the most similar candidate characters after the user finishes the inputting procedure of the whole character.

In addition, the selecting module 130 can be set by the user to automatically select a candidate character which is most similar to the trajectory information from the candidate characters as the objective character.

To sum up, the virtual input system 1 can determine a character similar with the moving trajectory to input the character according to the moving trajectory generated by the user when he/she moves the trajectory generating apparatus 10 in the air. Practically, the virtual input system 1 is not limited to input Chinese characters; it can also be applied to Japanese, English, or other kinds of characters. Similarly, the virtual input system 1 can also be applied to input drawings, numbers, or symbols, but not limited to this embodiment.

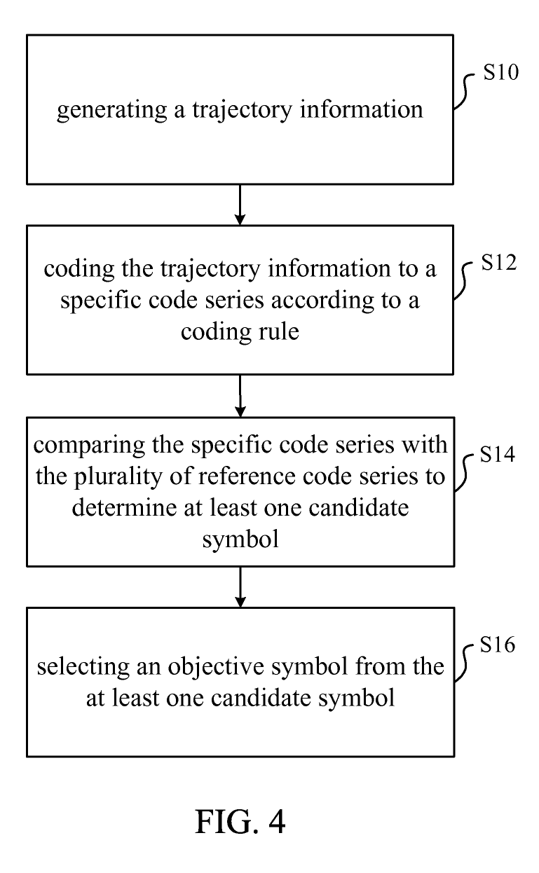

The virtual input method, according to the second embodiment of the invention, converts the moving trajectory generated by the user when he/she moves the trajectory generating apparatus in the air to the input symbol via the coding method, so that the user can easily input the characters. The symbol described in this embodiment can be a character, a number, a drawing, or those of other forms. Please refer to FIG. 4. FIG. 4 illustrates a flowchart of the virtual input method. Next, the steps of the virtual input method will be respectively introduced as follows.

As shown in FIG. 4, firstly, step S10 is performed to generate a trajectory information. Practically, the method can sense the at least one moving trajectory formed when the trajectory generating apparatus or the virtual input system moves in the air to get the trajectory information.

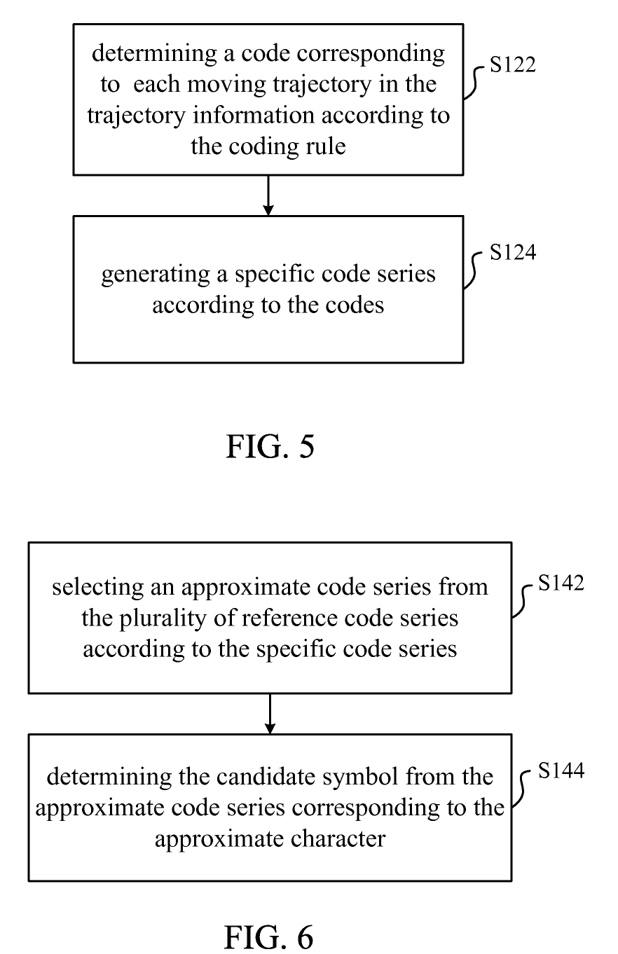

Next, step S12 is performed to code the trajectory information to a specific code series according to a coding rule. As shown in FIG. 5, in this embodiment, step S12 can be further divided into two sub-steps S122 and S124. In sub-step S122, the method respectively determines the specific code corresponding to each moving trajectory in the trajectory information according to the coding rule. Next, sub-step S124 is preformed to generate a specific code series according to the specific code determined in sub-step S122.

Namely, after the method senses the trajectory information when the user moves the trajectory generating apparatus, each moving trajectory of the trajectory information will be arranged by the moving sequence of the user, so the method will orderly code each moving trajectory in the trajectory information to its corresponding specific code according to the coding rule. Therefore, the trajectory information will be coded to one set of specific codes including these specific code series.

After the trajectory information is coded to the specific code series, step S14 is performed to determine at least one candidate symbol according to the specific code series and the plurality of reference code series. As shown in FIG. 6, in this embodiment, step S14 can be further divided into two sub-steps S142 and S144. Step S142 is performed to select an approximate code series from the plurality of reference code series according to the specific code series; step S144 is performed to determine the candidate symbol according to an approximate symbol corresponding to the approximate code series.

After step S14 is performed to determine one or more candidate symbols, the method will perform step S16 to select an objective symbol from candidate symbols. In practical applications, the user can select the objective symbol he/she wants to input from these candidate symbols.

In practical applications, after step S10 is performed, the method will perform some pre-processing procedures to the sensed trajectory information, such as the process of canceling the noise, the vibration, and adjusting the trajectory. The purpose of performing these processes by the method is to avoid the following difficulty of judging the trajectory information due to the factors of vibration and noise, and the accuracy percentage can be also increased accordingly.

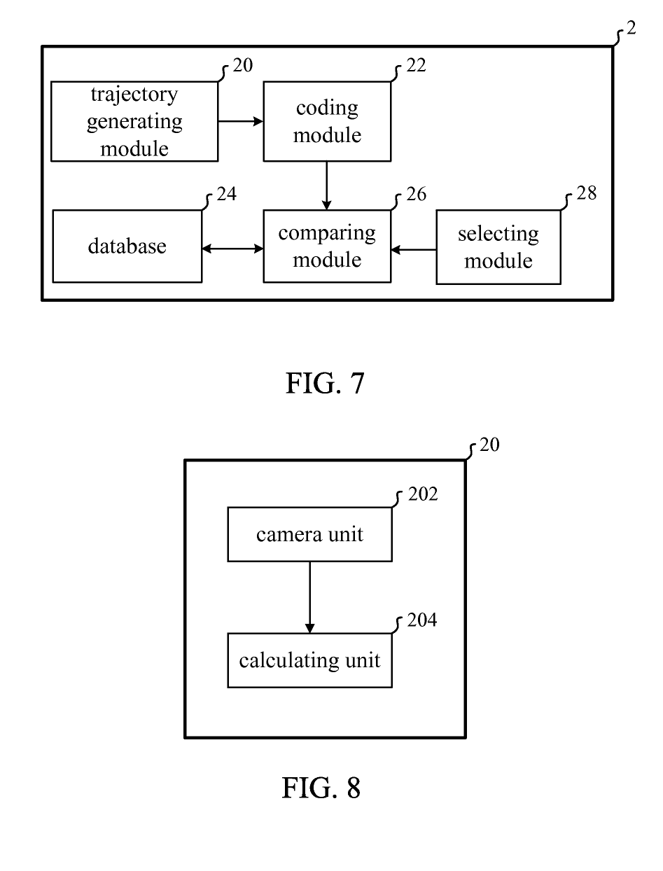

A third embodiment of the invention is a virtual input system. In fact, the virtual input system can be a portable electronic apparatus, such as a mobile phone, a PDA, a handheld game device, a global position system (GPS) apparatus, or a stock information viewing apparatus. Please refer to FIG. 7. FIG. 7 illustrates a functional block diagram of the virtual input system.

As shown in FIG. 7, the virtual input system 2 includes a trajectory generating module 20, a coding module 22, a database 24, a comparing module 26, and a selecting module 28, wherein the coding module 22 is coupled to the trajectory generating module 20; the comparing module 26 is coupled to the coding module 22 and the database 24; the selecting module 28 is coupled to the comparing module 26. Next, each of the modules of the virtual input system 2 and their functions will be respectively introduced in detail as follows.

Firstly, the trajectory generating module 20 of the virtual input system 2 is used for sensing a trajectory information of the virtual input system 2 itself. In fact, the trajectory information can include a plurality of discontinuous moving trajectories or a plurality of continuous moving trajectories formed when the virtual input system 2 is moved.

In this embodiment, the function of the trajectory generating module 20 is to capture a plurality of environment images responding to the movement of the virtual input system 2, and to get the trajectory information of the virtual input system 2 according to the plurality of environment images.

In detail, the trajectory generating module 20 can include a camera unit 202 and a calculating unit 204, as shown in FIG. 8. When the user moves the virtual input system 2 in the air to input a symbol, the camera unit 202 of the trajectory generating module 20 will capture the plurality of environment images during the movement of the virtual input system 2. Then, the calculating unit 204 will calculate the plurality of environment images to get the trajectory information of the virtual input system 2 according to the plurality of environment images.

After the coding module 22 receives the trajectory information from the trajectory generating module 20, the coding module 22 will code the trajectory information to a specific code series according to a coding rule. In this embodiment, the specific code series includes at least one code corresponding to the trajectory information. The coding rule includes the corresponding relationship between the moving trajectory and the specific code, so it can help the coding module 22 to code each of the moving trajectories in the trajectory information to its corresponding specific code, and generate the specific code series corresponding to the trajectory information according to all of the coded specific codes.

In this embodiment, the database 24 stores a plurality of reference code series and a plurality of reference symbols corresponding to the plurality of reference code series, therefore, after the coding module 22 codes the trajectory information to the specific code series by the trajectory generating module 20, the comparing module 26 can compare the specific code series with the plurality of reference code series, and determines one or more candidate symbol from the plurality of reference symbols according to the comparing result for the user to select.

After the comparing module 26 finishes the comparing work and gets the candidate symbol corresponding to the trajectory information, the selecting module 28 is used for selecting the objective symbol corresponding to the trajectory information from the candidate symbols. Practically, the embodiment describes that the symbol can be a character, a number a drawing, or other forms. As to the detailed operating of the virtual input system 2, it can refer to the related explanation of the first embodiment above, so it will not be described again here.

Compared to the prior art, the virtual input system and method of the invention can provide the user with a new human-machine interacting mode. When the user wants to input a character, the user only needs to move the trajectory generating apparatus in the air to write the character, the virtual input system will sense the moving trajectory of the trajectory generating apparatus, and determine candidate characters similar to the moving trajectory according to the moving trajectory, so that the users can select the correct character from the candidate characters. Accordingly, the virtual input system can be applied to a general portable electronic apparatus to provide the user with a convenient and humanized character inputting method, and the various problems in the conventional character inputting method can be solved.

Although the present invention has been illustrated and described with reference to the preferred embodiment thereof, it should be understood that it is in no way limited to the details of such embodiment but is capable of numerous modifications within the scope of the appended claims.

What is claimed is:

1. A virtual input system, comprising:
a trajectory generating apparatus for generating a trajectory information; and
a receiving apparatus, comprising:
a sensing module for sensing the trajectory information;
a coding module, coupled to the sensing module, the coding module coding the trajectory information to a specific code series according to a coding rule;
a database, the database storing a plurality of reference code series and a plurality of reference symbols, the plurality of reference code series corresponding to the plurality of reference symbols; and
a comparing module, coupled to the coding module and the database, the comparing module comparing the specific code series with the plurality of reference code series to determine at least one candidate symbol from the plurality of reference symbols.

2. The virtual input system of claim 1, further comprising:
a selecting module, coupled to the comparing module, for selecting an objective symbol from the at least one candidate symbol.

3. The virtual input system of claim 2, wherein the selecting module comprises a user interface for providing a user with the convenience to select the objective symbol from the at least one candidate symbol.

4. The virtual input system of claim 1, wherein the trajectory information comprises a plurality of discontinuous moving trajectories.

5. The virtual input system of claim 1, wherein the trajectory information comprises at least one continuous moving trajectory.

6. The virtual input system of claim 1, wherein the trajectory information is formed by a user to move the trajectory generating apparatus.

7. The virtual input system of claim 1, wherein the specific code series comprises at least one code corresponding to the trajectory information.

8. The virtual input system of claim 1, wherein the sensing module comprises:
a noise cancellation unit, when the trajectory information comprises a noise, and the noise cancellation unit cancels the noise.

9. The virtual input system of claim 1, wherein the sensing module comprises:
a vibration cancellation unit, when the trajectory information generates a vibration, and the vibration cancellation unit cancels the vibration.

10. The virtual input system of claim 1, wherein the sensing module comprises:
a trajectory adjusting unit, when the trajectory information deviates a default trajectory information, and the trajectory adjusting unit adjusts the trajectory information.

11. A virtual input system, comprising:
a trajectory generating module for generating a trajectory information;
a coding module, coupled to the trajectory generating module, the coding module coding the trajectory information to a specific code series according to a coding rule;
a database, the database storing a plurality of reference code series and a plurality of reference symbols, the plurality of reference code series corresponding to the plurality of reference symbols; and
a comparing module, coupled to the coding module and the database, the comparing module comparing the specific code series with the plurality of reference code series to determine at least one candidate symbol from the plurality of reference symbols.

12. The virtual input system of claim 11 further comprising:
a selecting module, coupled to the comparing module, for selecting an objective symbol from the at least one candidate symbol.

13. The virtual input system of claim 11, wherein the trajectory generating module captures the plurality of environment images responding to the movement of the virtual input system and the trajectory generating module generates the trajectory information according to the plurality of environment images.

14. The virtual input system of claim 11, wherein the trajectory information comprises a plurality of discontinuous moving trajectories.

15. The virtual input system of claim 11, wherein the trajectory information comprises at least one continuous moving trajectory.

16. The virtual input system of claim 11, wherein the specific code series comprises at least one code corresponding to the trajectory information.

17. A virtual input method, comprising the steps of:
(a) generating a trajectory information;
(b) coding the trajectory information to a specific code series according to a coding rule;
(c) comparing the specific code series with the plurality of reference code series to determine at least one candidate symbol from the plurality of reference symbols, wherein the plurality of reference code series corresponding to the plurality of reference symbols.

18. The virtual input method of claim 17, further comprising the step of:
(d) selecting an objective symbol from the at least one candidate symbol.

19. The virtual input method of claim 17, wherein the trajectory information comprises a plurality of discontinuous moving trajectories.

20. The virtual input method of claim 17, wherein the trajectory information comprises the at least one continuous moving trajectory.

21. The virtual input method of claim 17, wherein the specific code series comprises the at least one code corresponding to the trajectory information.
